(19) United States
(12) Patent Application Publication
(10) Pub. No.: US 2011/0045741 A1
(43) Pub. Date: Feb. 24, 2011

(54) Auto-Stopping Abrasive Composition for Polishing High Step Height Oxide Layer

(75) Inventors: Jung-Ryul Ahn, Daejeon (KR); Jong-Kwan Park, Gongju-city (KR); Seok-Ju Kim, Gongju-city (KR); Eun-Il Jeong, Daejeon (KR); Deok-Su Han, Daejeon (KR); Hyu-Bum Park, Yeonki-gun (KR); Kui-Jong Baek, Daejeon (KR); Tae-Kyeong Lee, Gongju-city (KR)

Correspondence Address: THE WEBB LAW FIRM, P.C., 700 KOPPERS BUILDING, 436 SEVENTH AVENUE, PITTSBURGH, PA, 15219, US

(73) Assignee: TECHNO SEMICHEM CO., LTD., Seongnam-city (KR)

(21) Appl. No.: 11/912,849

(22) PCT Filed: Apr. 28, 2006
(86) PCT No.: PCT/KR2006/001619

§ 371 Date: Apr. 16, 2008

(30) Foreign Application Priority Data
Apr. 28, 2005 (KR) 10-2005-0035316
Feb. 9, 2006 (KR) 10-2006-0012370

(51) Int. Cl. C09K 13/06; B24B 1/00; C09K 13/00

(52) U.S. Cl. 451/28; 252/79.1; 252/79.4

(57) ABSTRACT

Disclosed is a chemical-mechanical polishing composition used in a process for chemical-mechanical polishing of silicon oxide layer having severe unevenness with large step-height. The composition includes abrasive particles of metal oxide; and at least one compound(s) selected from the group consisting of amino alcohols, hydroxycarboxylic acid having at least 3 of the total number of carboxylic acid group(s) and hydroxyl group(s) or their salts, or a mixture thereof. A polymeric organic acid, a preservative, a lubricant and a surfactant may be further contained. The composition shortens the vapor-deposition time of a layer to be polished, saves the raw material to be vapor-deposited, shortens the chemical-mechanical polishing time, and saves the slurry employed.

### TECHNICAL FIELD

The present invention relates to an auto-stopping chemical-mechanical polishing composition, utilized for polishing semiconductor devices having large unevenness with high step-height, and a process for chemical-mechanical polishing using the same composition.

### BACKGROUND ART

As semiconductor elements have been made with higher minuteness and higher density, techniques for forming much minute patterns have been utilized, and thus the surface structure of a semiconductor device becomes more complicated with higher step-heights of the surface layers. As a planarization technique for removing step-heights in a particular layer formed on a substrate in manufacturing a semiconductor device, a CMP process is employed. As the integrity becomes higher and the specifications for process become stricter, a need occurs for rapidly planarizing an insulating layer having very large step-height. For example, it is the case of chemical-mechanical polishing of a silicon oxide layer with very high step-height which have been coated on for insulation after fabricating DRAM capacitor.

If the step-height is rapidly removed in polishing a layer having high step-height and the removal rate becomes very slow after the removal of step-height to give auto-stopping function, it is advantageous in that productivity can be enhanced by reducing the cost of raw materials, increasing the process margin, and shortening the process time, with following advantages:
1) Shortening the vapor-deposition time of a layer to be polished and saving the raw material of vapor-deposition;
2) Shortening the chemical-mechanical polishing time and saving the slurry to be used;
3) Increasing the process margin.

Thus it is required to develop a polishing composition having auto-stopping function, which has high rate of removing the step-height at the initial stage of polishing but the rate becomes very low after removal of the step-height.

In the meanwhile, with respect to an polishing composition of an oxide layer on a semiconductor substrate, Korean Patent Laid-Open No. 2005-4051 discloses a slurry composition containing cerium oxide as an abrasive, carboxylic acid or a salt thereof, and an alcoholic compound; Korean Patent Laid-Open No. 2004-16154 discloses an aqueous solution comprising abrasive particles of metal oxide, promoter for removal rate, an anionic polymer passivating agent having from 1,000 to 100,000 of molecular weight, and an anionic passivating agent having from 1 to 12 carbon atoms, but those are polishing slurries for fabricating STI (shallow trench isolation) with high selectivity ratio of oxide layer to nitride layer.

With respect to polishing compositions having a function of film formation by virtue of additive(s) in a polishing composition of oxide layer on a semiconductor substrate, or thereby having auto-stopping function, Korean Patent Laid-Open No. 2001-7534 discloses a CMP process containing abrasive particles having surface potential adjusted to negative value and a surfactant consisting of water-soluble polymers; Korean Patent Laid-Open No. 1996-5827 discloses an CMP process using an abrasive liquid comprising an organic compound having at least one hydrophilic group selected from the group consisting of COOH (carboxylic group) and COOM1 (M1 is an atom or a functional group which can form a salt by substitution with a hydrogen atom of sulfonyl group or a hydrogen atom of carboxylic group) with at least 100 of molecular weight; and Korean Patent Laid-Open No. 1998-63482 discloses an polishing composition which further comprises a polyelectrolyte having ionic moieties being different from the charge of the abrasive particles, and having from about 500 to about 10,000 of molecular weight and from about 5 to 50% by weight of concentration on the basis of the abrasive particles; the conventional polishing compositions, however, do not exhibit evident auto-stopping function to be applied to actual process for semiconductor manufacturing.

Korean Patent Laid-Open No. 2003-53138 discloses a polishing composition comprising fumed silica and/or colloidal silica, pH modifier, fluorine compound(s), anionic additive(s) of phosphate type, amine-type additives such as triethanol amine, oxidant(s) and water; but the polishing composition does not show auto-stopping function, which the present invention intends, and the composition of additional ingredients is different.

### DISCLOSURE

### Technical Problem

The present inventors have found that a composition containing an amino alcohol such as triethanol amine (TEA) and 2-dimethylamino-2-methyl-1-propanol (DMAMP) or a hydroxycarboxylic acid which has the number of carboxylic group plus hydroxyl group of at least 3 exhibits excellent auto-stopping function after removing the unevenness of oxide layer on a semiconductor substrate, and the auto-stopping function further improves when using the hydroxycarboxylic acid together with an aminoalcohol, to complete the present invention.

Thus, the object of the present invention is to provide a polishing composition which rapidly removes step-height, at the initial stage, by rapidly removing the convex portion with hardly polishing concave portion of the layer to be polished having severe unevenness with large step-height, and, after removing the step-height, the removal rate is much lowered so that the polishing is auto-stopped. Another object of the present invention is to provide a polishing composition having auto-stopping function to shorten the vapor-deposition time of the layer to be polished, saving the material to be deposited, shortening the chemical-mechanical polishing time, and saving of the slurry employed.

### Technical Solution

The present invention relates to a chemical-mechanical polishing composition which is employed in planarization by rapidly polishing a patterned wafer consisting of silicon oxide having severe unevenness with large step-height in manufacturing technology of semiconductor device, and a process for chemical-mechanical polishing using the same, and specifically, the composition has auto-stopping function that initially provide high rate of removing step-height, but after planarization by removing step-height, the removal rate is much lowered, being characterized in that it comprises
i) abrasive particles of metal oxide; and
ii) at least one compound(s) selected from the group consisting of an amino alcohol represented by Chemical Formula 1, a hydroxycarboxylic acid represented by Chemical Formula 2 or its salt, or a mixture thereof:

R₁—N(R₂)-A-OH [Chemical Formula 1]

(OH)ₙ—R—(COOH)ₘ [Chemical Formula 2]

wherein, A represents a linear or branched alkylene having from 2 to 5 carbon atoms, each group of R₁ and R₂ independently represent hydrogen or a linear or branched alkyl having from 1 to 5 carbon atom(s) with or without —OH substituent, R represents a linear or branched alkylene having from 1 to 6 carbon atom(s), a cycloalkylene having from 5 to 7 carbon atoms, a phenylene or an aralkylene group having from 7 to 9 carbon atoms, each of n and m represents an integer not less than 1, and n+m is not less than 3.

The polishing composition according to the present invention contains a chemical substance, which can effect auto-stopping polishing that inhibits polishing by being adsorbed on the oxide layer. When an oxide layer having high step-height is polished by using a polishing composition according to the present invention, the convex portion is subjected to strong physical pressure at the initial stage of polishing so that the polishing function of abrasive particles strongly effect, while on the concave portion, an auto-stopping agent adsorbed on the layer to be polished forms a film on the surface of the layer to be polished to inhibit polishing to evidently lower the removal rate. As the polishing proceeds, the step-height between the convex portion and the concave portion becomes smaller and diminishes. At this time, the function of the polishing inhibition layer formed on the layer to be polished is larger than the physical polishing due to the pressure, thereby evidently lowering the removal rate.

The abrasive particles containing the polishing composition according to the present invention are selected from the group consisting of silica, cerium oxide, zirconium oxide and aluminum oxide. It is preferable to use cerium oxide since it has very high removal rate on the surface comprising silicon oxide such as glass or semiconductor substrate to be advantageous in polishing of a semiconductor substrate, even though it has lower hardness than silica particles or aluminum oxide particles. In the present invention, the employed cerium oxide was prepared by calcining cerium carbonate hydrate at a temperature between 600° C. and 900° C. in the air.

The content of abrasive particles is important to provide sufficient rate to remove step-height, and the amount used may be varied depending on the desired removal rate because the removal rates with the same content may be different from each other depending on the type of particles. In case of cerium oxide, the content of the abrasive particles is from 0.1 to 20% by weight, preferably from 0.5 to 5% by weight, and more preferably from 1 to 3% by weight. Lower content may tend to slow down the rate of removing step-height, and larger content is likely to cause polishing defects and lower the auto-stopping function of polishing. The size of cerium oxide abrasive particles, as considering the scratch and removal rate, is preferably from 50 nm to 500 nm of secondary particle diameter in the dispersion, and more preferably from 80 to 300 nm. The smaller the particle size, the lower the removal rate; the larger the particle size, the higher the frequency of occurrence of polishing defects.

The polishing composition according to the present invention comprises, an agent for auto-stopping the polishing, at least one compound(s) selected from the group consisting of an amino alcohol represented by Chemical Formula 1, a hydroxycarboxylic acid represented by Chemical Formula 2 and salts thereof, or a mixture thereof:

R₁—N(R₂)-A-OH [Chemical Formula 1]

(OH)ₙ—R—(COOH)ₘ [Chemical Formula 2]

wherein, A represents a linear or branched alkylene having from 2 to 5 carbon atoms, each group of R₁ and R₂ independently represent hydrogen or a linear or branched alkyl having from 1 to 5 carbon atom(s) with or without —OH substituent, R represents a linear or branched alkylene having from 1 to 6 carbon atom(s), a cycloalkylene having from 5 to 7 carbon atoms, a phenylene or an aralkylene group having from 7 to 9 carbon atoms, each of n and m represents an integer selected from 1 to 7, and n+m is not less than 3.

The compound represented by Chemical Formula 1 is exemplified as triethanol amine, 2-dimethylamino-2-methyl-1-propanol, 1-amino-2-propanol, 1-dimethylamino-2-propanol, dimethylamino-1-propanol, 2-diethylamino-1-propanol, 2-diethylamino-1-ethanol, 2-ethylamino-1-ethanol, 1-(dimethylamino)-2-propanol, diethanolamine, N-methyldiethanolamine, N-propyldiethanolamine, N-isopropyldiethanolamine, N-(2-methylpropyl)diethanolamine, N-n-butyldiethanolamine, N-t-butylethanolamine, N-cyclohexyldiethanolamine, N-dodecyldiethylamine, 2-(dimethylamino)ethanol, 2-diethylaminoethanol, 2-dipropylaminoethanol, 2-butylaminoethanol, 2-t-butylaminoethanol, 2-cycloaminoethanol, 2-amino-2-pentanol, 2-[bis(2-hydroxyethyl)amino]-2-methyl-1-propanol, 2-[bis(2-hydroxyethyl)amino]-2-propanol, N,N-bis(2-hydroxypropyl)ethanolamine, 2-amino-2-methyl-1-propanol, tris(hydroxymethyl)aminomethane (Trizma) and triisopropanolamine (TIPA), and the compound may be used alone or in a combination.

Preferable aminoalcohol compound represented by Chemical Formula 1, which is contained in the polishing composition having auto-stopping function of polishing is triethanol amine, 2-dimethylamino-2-methyl-1-propanol, tris(hydroxymethyl)aminomethane or triisopropanolamine, or a mixture thereof.

An aminoalcohol is a compound having both an amine group as a functional group with hydrophilic and basic property and a hydroxyl group as a functional group being capable of hydrogen bond, which is adsorbed on the surface of oxide layer and serve to inhibit polishing under low pressure. It is considered that such functions are shown because the silicon oxide layer has negative zeta-potential and aminoalcohol molecules tend to be positively charged in a very wide pH range of weak basic, neutral and acidic pH to be adsorbed with attractive force between them.

The appropriate amount of aminoalcohol used in the polishing composition according to the present invention varies depending on the content and size of abrasive particles and contents and pH of other constituents. The content to show high rate of removing step-height and the function of auto-stopping polishing is from 0.5 to 15% by weight, preferably from 1 to 10% by weight, more preferably from 2 to 6% by weight. If the content of auto-stopping agent is too low, the auto-stopping function is feeble, while if it is too high, the rate of removing step-height at the initial stage of polishing decreases.

The compound represented by Chemical Formula 2 is a hydroxycarboxylic acid having the number of carboxylic group plus hydroxyl group of at least 3. As an auto-stopping agent according to the present invention, a compound selected from said hydroxycarboxylic acid or its salt, or a mixture thereof can be contained.

The salt of hydroxycarboxylic acid, represented by Chemical Formula 2, is formed by the combination with monovalent cation or divalent cation. The examples of said monovalent cation include K, NH₄ and primary, secondary, tertiary and quaternary ammonium cation such as NR₄ (R: hydrogen or C1˜C7 alkyl group), and those of said divalent cation include Ca, Mg, Cu, or the like.

As a compound selected from the group consisting of hydroxycarboxylic acids, and salts thereof, or a mixtures thereof according to the present invention preferably has at least 3 (more preferably has at least 4) of the total number of COOH and OH. When the total number of COOH and OH is less than 3, the difference between the rate of removing step-height and the removal rate of plane plate was not high, thereby substantial auto-stopping function could not be obtained.

The hydroxycarboxylic acids according to the present invention include gluconic acid, glucoheptonic acid, citric acid, tartaric acid, malic acid, citramalic acid, ketomalonic acid, dimethylolpropionic acid, diethylolpropionic acid, dimethylolbutyric acid, diethylolbutyric acid, glyceric acid, galactaric acid, saccharic acid, quinic acid, pentaric acid, 2,4-dihydroxybenzoic acid, gallic acid or the like. The hydroxycarboxylic acid may be used alone or in a combination.

The content of the compound selected from the group consisting of hydroxycarboxylic acids, salts thereof or a mixture thereof according to the present invention is from 0.01 to 15% by weight, preferably from 0.05 to 10% by weight, and more preferably from 0.1 to 5% by weight. If the content of auto-stopping agent is too low, the auto-stopping function is feeble, but if too high, the rate of removing step-height at the initial stage decreases.

It is more preferable because of strengthened auto-stopping function, if the polishing composition according to the present invention comprises a compound selected from the group consisting of hydroxycarboxylic acids represented by Chemical Formula 2 or salts thereof, or a mixture thereof, together with an aminoalcohol represented by Chemical Formula 1. More preferred aminoalcohol compounds include triethanol amine, diethanolamine, monoethanolamine, 2-dimethylamino-2-methyl-1-propanol, tris(hydroxymethyl)aminomethane or triisopropanolamine or mixtures thereof. Preferred content of aminoalcohol, when it is employed with a compound selected from the group consisting of hydroxycarboxylic acids and salts thereof, or a mixture thereof, is from 0.01 to 10% by weight, preferably from 0.05 to 5% by weight, more preferably from 0.1 to 3% by weight. If the aminoalcohol content is too low, the auto-stopping function is feeble, but if too high, the rate of removing step-height decreases.

The polishing composition according to the present invention further comprises a pH modifier, a quaternary ammonium compound, a surfactant, a lubricant, a polymeric organic acid, a preservative or the like, if required, in addition to said abrasive particles of metal oxide and auto-stopping agent. The present invention is achieved by polishing function of the abrasive particles in combination with a function to suppress the removal rate of plate by the auto-stopping agent.

The polishing composition having auto-stopping function according to the present invention is effective in a wide pH range; but if pH is too low or too high, the rate of removing step-height lowers, or the auto-stopping function weakens. Preferred pH range is from pH 4 to 11, more preferably from pH 5 to 8. As a pH modifier to adjust pH, any acid selected from inorganic acids such as nitric acid, hydrochloric acid, sulfuric acid, perchloric acid or organic acids, or any inorganic or organic base may be used, which can adjust pH of the composition without providing adverse effect on the properties of the polishing composition, including high rate of removing step-height and auto-stopping function.

The polishing slurry for semiconductor manufacturing according to the present invention may further comprise a quaternary ammonium salt selected from the group consisting of ammonium hydroxide, tetramethylammonium hydroxide, tetraethylammonium hydroxide, tetrapropylammonium hydroxide, tetrabutylammonium hydroxide, and the like. The quaternary ammonium salt additionally serves as a preservative or a pH modifier, and the amount used is from 0.01 to 10% by weight, more preferably from 0.1 to 5% by weight.

Other surfactants and lubricants, which help lubricating function may be included. Since a cationic surfactant having high molecular weight may cause the problem of resulting in rapid sedimentation at the time of being mixed with a cerium oxide dispersion, an anionic or non-ionic surfactant is advantageously used. Examples of lubricant include glycerin and ethylene glycol. The amount of a surfactant used is from 0.0001 to 0.5% by weight, preferably from 0.001 to 0.1% by weight. The amount of lubricant used may be from 0.01 to 10% by weight, preferably from 0.1 to 5% by weight.

The polymeric organic acid serves to enhance the rate of removing step-height. As the polymeric organic acid, a water-soluble polymer having acidic groups may be used. Polyacrylic acid or polyacrylic acid copolymer or a mixture thereof may be preferably used. Commercially available polyacrylic acid products frequently have no notification of molecular weight, and generally marketed as aqueous solutions, so that the content of polyacrylic acid is different in every product. An aqueous 2.5% polyacrylic acid solution having a viscosity from 0.8 to 20 cps was used in the additive for polishing slurry for semiconductors according to the present invention. For instance, viscosity of aqueous 2.5% polyacrylic acid solution used in the present invention was 1.67 cps for polyacrylic acid L, 1.21 cps for polyacrylic acid S (manufactured by Nippon Zunyaku Kabushikikaisha). The content of polymeric organic acid preferably is from 0.1 to 10% by weight, and more preferably from 0.3 to 5% by weight. If the content of polymeric organic acid is too low, the effect of enhancing the removal rate of step-height is low, while if it is too high, the removal rate rather decreases.

As the polyacrylic acid, excellent effect can be obtained if a mixture of polyacrylic acid S of low viscosity and polyacrylic acid L of high viscosity is used, and the content ratio of the polyacrylic acid of low viscisity to that of high viscosity is preferably from 5 to 95% by weight: from 95 to 5% by weight.

When only polyacrylic acid of low viscosity is used, the rate of removing step-height at the initial stage of polishing tends to be low, while when only polyacrylic acid of high viscosity is used, the rate of removing step-height is high but the removal rate after removal of the step-height becomes high to weaken the auto-stopping function.

The composition according to the present invention consists of organic acids so that change in appearance may occur owing to spoiling by attack of microorganisms or bacteria. In order to avoid such spoiling a preservative may be used. Any preservative, which can inhibit spoiling of constituent(s) of the slurry composition according to the present invention, may be employed. Isothiazoline compounds may be used as the preservative, with 5-chloro-2-methyl-4-isothiazolin-3-one, 2-methyl-4-isothiazolin-3-one or 2-methyl-3-isothiazolone being preferable. If the content of the preservative is too low, preserving function is feeble, while if it is too high, it inhibits the function as an abrasive.

A preferable polishing composition having auto-stopping function according to the present invention which contains aminoalcohol as an auto-stopping agent comprises from 0.1 to 20% by weight of metal oxide abrasive particles, from 0.5 to 15% by weight of an aminoalcohol compound or a mixture thereof on the basis of total weight of the polishing composition, more preferably it comprises from 0.5 to 5% by weight of metal oxide abrasive particles, from 1 to 10% by weight of an aminoalcohol compound represented by Chemical Formula 1 or a mixture thereof on the basis of total weight of the polishing composition, and is within the pH range from 4 to 11, in particular, from 5 to 8. As another polishing composition, the most preferable is a composition comprising from 1 to 3% by weight of cerium oxide, from 2 to 6% by weight of triethanol amine and from 0.1 to 10% by weight of polyacrylic acid, within the pH range from 5 to 8.

A preferable polishing composition having auto-stopping function according to the present invention which contains a hydroxycarboxylic acid or a salt thereof comprises from 0.1 to 20% by weight of metal oxide abrasive particles, from 0.01 to 15% by weight of a compound selected from a compound selected from the group consisting of hydroxycarboxylic acids and salts thereof, or a mixture thereof on the basis of total weight of the polishing composition, more preferably it comprises from 0.5 to 5% by weight of metal oxide abrasive particles, from 0.05 to 10% by weight of a compound selected from the group consisting of hydroxycarboxylic acid and salts thereof, or a mixture thereof on the basis of total weight of the polishing composition, and is within the pH range from 4 to 11, and most preferably, within the pH range from 5 to 8.

A preferable polishing composition having auto-stopping function according to the present invention which contains a hydroxycarboxylic acid or its salt and aminoalcohol comprises from 0.1 to 20% by weight of metal oxide abrasive particles, from 0.01 to 10% by weight of an aminoalcohol represented by Chemical Formula 1 or a mixture thereof, and from 0.01 to 15% by weight of a hydroxycarboxylic acid represented by Chemical Formula 2, its salt or a mixture thereof on the basis of total weight of the polishing composition, and is within the pH range from 4 to 11. More preferable composition comprises from 0.5 to 5% by weight of cerium oxide, from 0.05 to 10% by weight of a compound selected from the group consisting of hydroxycarboxylic acids and salts thereof, or a mixture thereof, and from 0.05 to 5% by weight of an aminoalcohol, and is within the pH range from 5 to 8. The most preferable composition comprises from 1 to 3% by weight of cerium oxide, from 0.1 to 5% by weight of gluconic acid or its salt, and from 0.1 to 3% by weight of triethanol amine, and is within the pH range from 5 to 8.

The auto-stopping polishing slurry according to the present invention can be utilized for the purpose of planarization of layer during a manufacturing process for semiconductors on which an auto-stopping polishing layer can be formed from the composition of the present invention, as well as a silicon oxide layer having high step-height.

### DESCRIPTION OF DRAWINGS

FIG. 1 is a cross-sectional view of a semiconductor substrate having high step-height;

FIG. 2 shows mean thickness of the convex portion and concave portion versus polishing time as a result of Example 7 according to the present invention;

FIG. 3 shows change of thickness of the convex portion before and after polishing depending upon pitch and pattern density as a result of Example 7 according to the present invention;

FIG. 4 shows mean thickness of the convex portion and concave portion versus polishing time as a result of Example 14 according to the present invention;

FIG. 5 shows change of thickness of the convex portion before and after polishing depending upon pitch and pattern density as a result of Example 14 according to the present invention.

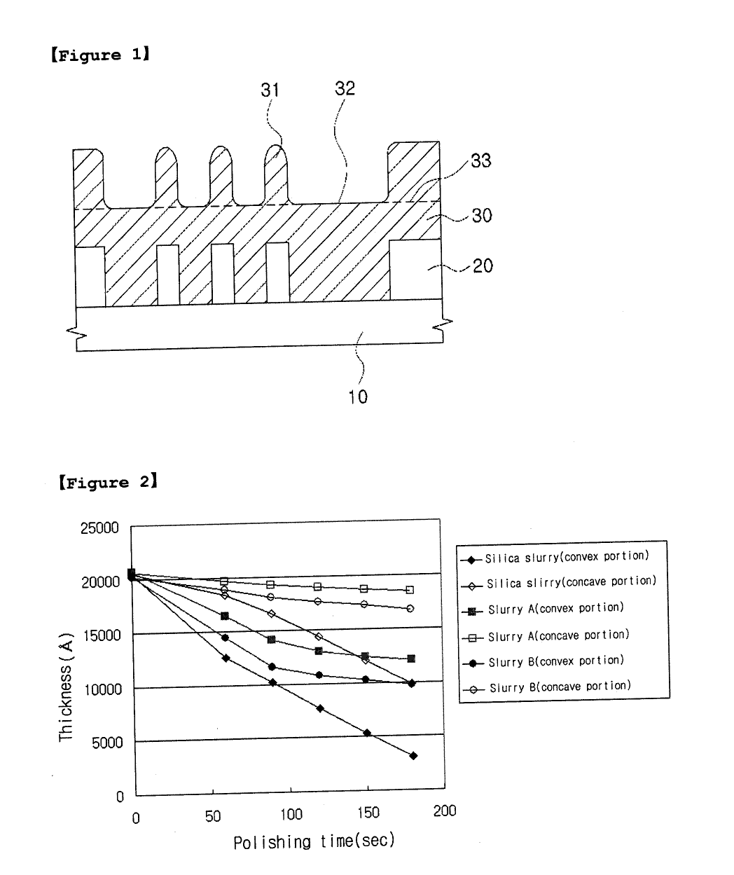

### DESCRIPTION OF IMPORTANT PARTS OF THE DRAWINGS

10—a substrate
20—a wiring pattern or a capacitor
30—an insulating layer
31—a convex portion
32—a concave portion
33—an ideal polishing stopping face

### BEST MODE

### Mode for Invention

Now, the present invention is described in more detail with referring to Examples, which is to provide more understanding with regard to the construction and effect of the invention, but not to restrict the scope of the invention.

### Example 1

Cerium carbonate hydrate was calcined at 750° C. for 4 hours in the air to prepare cerium oxide. After adding deionized water and a small amount of dispersant thereto, and pulverizing and dispersing by the use of a media-agitating type powder pulverizer, deionized water was finally added thereto to obtain a dispersion of cerium oxide with solid content of 5%. The particle size of the dispersion was 140 nm, and pH was 8.4. As an additive having auto-stopping function, an abrasive additive was prepared by mixing triethanol amine and other alcohol with adjusting the pH by using nitric acid. The additive thus obtained was mixed with the dispersion of abrasive particles to prepare an abrasive liquid. Separately, an abrasive liquid was prepared without using nitric acid as a pH modifier (Exp. No. 1-1 and 1-2). While maintaining the concentration of cerium oxide as 1%, the amount of aminoalcohol added and pH were varied as shown in Table 1 to prepare individual abrasive liquids.

The substrate used in the chemical mechanical polishing was a substrate prepared by plasma CVD method by using tetraethoxy silane (TEOS) having a silicon oxide layer coated thereon, and patterned with various line width and density on the Si substrate and vapor-deposited with silicon oxide layer having about 20000 Å of thickness, which had step-height of about 7000 Å at the uneven portion. In addition, a wafer plate on which a silicon oxide layer had been vapor-deposited by the same method was prepared in order to examine the removal rate after removal of the step-height. Each substrate was polished in a CMP equipment manufactured from G&P Tech. with 93 rpm and 87 rpm of revolution rate of board and head, respectively, with adjusting the pressure at 300 g/cm². Upon polishing, the content of cerium oxide in the abrasive liquid was 1% and the feed rate was 200 mL/min. Rate of removing step-height, removal rate of wafer plate and ratio of removal rate (rate of removing step-height/wafer plate) are shown in Table 1:

TABLE 1

| | Amino alcohol | | Rate of | Removal | |
|---|---|---|---|---|---|
| | and | | removing | rate of | |
| Exp. | concentration | | step-height | plate | Rate |
| No. | (%) | pH | (Å/min) | (Å/min) | ratio |
| 1-1 | TEA 4.0 | 10.3 | 1039 | 722 | 1.44 |
| 1-2 | TEA 6.0 | 10.5 | 970 | 409 | 2.37 |
| 1-3 | TEA 2.1 | 6.9 | 2271 | 1027 | 2.21 |
| 1-4 | TEA 4.2 | 5.0 | 1500 | 128 | 11.7 |
| 1-5 | TEA 4.2 | 6.9 | 2577 | 314 | 8.21 |
| 1-6 | TEA 4.2 | 8.0 | 2175 | 248 | 8.77 |
| 1-7 | TEA 6.3 | 6.9 | 2272 | 282 | 8.06 |
| 1-8 | TIPA 2.5 | 6.9 | 2906 | 1306 | 2.23 |
| 1-9 | TIPA 4.5 | 6.9 | 2531 | 980 | 2.58 |
| 1-10 | Trizma 4.2 | 6.9 | 2086 | 1232 | 1.69 |
| Comp. | none | 8.1 | 1428 | 3403 | 0.42 |
| 1-1 | | | | | |

TEA: triethanol amine
TIPA: triisopropanolamine
Trizma: tris (hydroxymethyl)aminomethane

As can be seen from Table 1, when it is polished with only cerium oxide without triethanol amine (Comp. 1-1), the rate of removing step-height of patterned wafer was lower than the removal rate of the wafer plate, but in case of Exp. 1-1 and 1-2 wherein only additional aminoalcohol was added, the removal rate after removal of step-height, that is the removal rate of plate was much reduced to increase the ratio of rate of removing step-height/removal rate of plate. In Exp. Nos. 1-3 to 1-10 wherein the pH was adjusted by using nitric acid, the removal rate of the wafer plate was much reduced but rate of removing step-height was increased, to highly raise the rate ratio as compared to Comp. Ex. 1-1.

It is also recognized that, as the amount of triethanol amine added increased, the removal rate of the wafer plate was lowered, but if the amount exceeded a certain amount the removal rate was maintained very low. Excellent auto-stopping function was exhibited in a pH range from 4 to 11.

The results from Example 1 are meaningful in that removal rate of a polishing composition according to the present invention with aminoalcohol added is much lowered after removal of step-height of a patterned substrate to show the function of auto-stopping the polishing.

### Example 2

To examine the effect of polyacrylic acid (PAA) added, evaluation was made as changing the amount added. Abrasive liquid was prepared according to the same procedure as Example 1, but polyacrylic acid was added and pH was firmly adjusted to 6.9.

The concentrations of polyacrylic acid and triethanol amine are shown in Table 2, and the polishing condition was identical to that of Example 1. The polyacrylic acid added was a product from Nippon Zunyaku, being a 3/7 w/w (L/S) mixture of polyacrylic acid L (viscosity of aqueous 2.5% solution was 1.67 cps) and polyacrylic acid S (viscosity 1.21 cps).

Rate of removing step-height of a pattern, removal rate of wafer plate and removal rate ratio depending on the amount of triethanol amine and polyacrylic acid added are shown in Table 2:

TABLE 2

| | | | Rate of | Removal | |
|---|---|---|---|---|---|
| | | | removing | rate of | |
| Exp. | Triethanol | | step-height | plate | Rate |
| No. | amine (%) | PAA(%) | (Å/min) | (Å/min) | ratio |
| 2-1 | 2.1 | 0.0 | 2271 | 1027 | 2.21 |
| 2-2 | 0.7 | 0.5 | 3460 | 3163 | 1.09 |
| 2-3 | 1.4 | 1.0 | 3739 | 2015 | 1.86 |
| 2-4 | 2.1 | 1.0 | 3402 | 413 | 8.24 |
| 2-5 | 2.1 | 1.5 | 3276 | 712 | 4.60 |
| 2-6 | 2.8 | 2.0 | 2938 | 338 | 8.69 |
| 2-7 | 3.5 | 2.5 | 2259 | 208 | 10.86 |

As can be seen from Table 2, addition of polyacrylic acid enhanced the rate of removing step-height, when polishing was carried out as changing the concentration of polyacrylic acid in the abrasive additive. In case that polyacrylic acid was further added to 2.1% of triethanol amine, the rate of removing step-height was prominently increased and the removal rate of wafer plate was reduced, to result in raise of the rate ratio. It is recognized that the removal rate ratio (rate of removing step-height/removal rate of wafer plate) increases as the amount of polyacrylic acid and triethanol amine increase.

### Example 3

In order to examine the dependency of triethanol amine content with the amount of polyacrylic acid being constant, polishing was carried out by preparing an abrasive agent having same composition as in Example 2 under the same polishing condition as in Example 1, but the concentration of polyacrylic acid added was 1% and 1.5%, and the amount of triethanol amine was changed as described in Table 3.

TABLE 3

| | | | Rate of | Removal | |
|---|---|---|---|---|---|
| | | | removing | rate of | |
| Exp. | | Triethanol | step-height | plate | Rate |
| No. | PAA(%) | amine (%) | (Å/min) | (Å/min) | ratio |
| 3-1 | 1 | 1.4 | 3739 | 2015 | 1.86 |
| 3-2 | | 1.5 | 3611 | 1782 | 2.03 |
| 3-3 | | 2.1 | 3402 | 413 | 8.24 |
| 3-4 | | 2.8 | 3162 | 211 | 15.0 |
| 3-5 | 1.5 | 1.5 | 3567 | 1681 | 2.12 |
| 3-6 | | 2.1 | 3276 | 712 | 4.60 |
| 3-7 | | 2.5 | 2976 | 226 | 13.2 |
| 3-8 | | 3.2 | 2946 | 160 | 18.4 |
| 3-9 | | 4.2 | 1872 | 120 | 15.6 |

From the results of Table 3, as the amount of triethanol amine is increased with constant amount of polyacrylic acid added, the removal rate of the plate abruptly reduces but the ratio of rate of removing step-height to removal rate of wafer plate tends to increase. If 2.1% or more amount of triethanol amine is added, the removal rate of wafer plate evidently reduces, so that polishing is automatically stopped after the removal of step-height.

### Example 4

In order to examine the properties of auto-stopping function depending on molecular weight of polyacrylic acid, two types of polyacrylic acid having different viscosities were mixed as described in Table 4, and triethanol amine was added thereto to prepare an abrasive additive with pH 6.9. After mixing cerium oxide slurry and said abrasive additive as a polishing composition to make 1% of cerium oxide, 1.3% of polyacrylic acid and 2.2% of triethanol amine, polishing was carried out under the same condition as described in previous Examples.

TABLE 4

| | | Rate of removing | Removal rate | |
|---|---|---|---|---|
| | Composition | step-height | of plate | |
| Exp. No. | of additives | (Å/min) | (Å/min) | Rate ratio |
| 4-1 | L/S(0/1)-TEA | 2074 | 222 | 9.34 |
| 4-2 | L/S(3/7)-TEA | 3340 | 405 | 8.25 |
| 4-3 | L/S(1/1)-TEA | 3634 | 740 | 4.91 |
| 4-4 | L/S(7/3)-TEA | 3768 | 695 | 5.42 |
| 4-5 | L/S(1/0)-TEA | 3414 | 1372 | 2.49 |

L: Polyacrylic acid L (aqueous 2.5% solution, viscosity 1.67 cps)
S: Polyacrylic acid S (aqueous 2.5% solution, viscosity 1.21 cps)

From the results of Table 4, it is recognized that if viscosity of polyacrylic acid is low (low average molecular weight) the removal rate of wafer plate reduces to provide excellent auto-stopping function, while a large amount of polyacrylic acid of high viscosity is employed, the removal rate after removal of step-height (that is, removal rate of plate) slightly increases. Such results confirm that an optimal point of two functions (removing step-height and auto-stopping) can be achieved by appropriately mixing polyacrylic acid of low viscosity and polyacrylic acid of high viscosity, depending on the purpose of polishing.

### Example 5

Rate of removing step-height and removal rate of plate were measured by using the same polishing condition described above, but the concentration of cerium oxide in the polishing composition was 1.0% and 1.5%, and the amounts of polyacrylic acid and triethanol amine were changed as listed in Table 5; and the removal rate ratio (rate of removing step-height/removal rate of plate) was thus calculated.

TABLE 5

| | | | | Rate of | Removal | |
|---|---|---|---|---|---|---|
| | Cerium | | Poly- | removing | rate of | |
| Exp. | oxide | Triethanol | acrylic | step-height | plate | Rate |
| No. | (%) | amine (%) | acid (%) | (Å/min) | (Å/min) | ratio |
| 5-1 | 1.0 | 2.1 | 1.5 | 3276 | 712 | 4.60 |
| 5-2 | | 2.8 | 2.0 | 2938 | 338 | 8.69 |
| 5-3 | | 3.5 | 2.5 | 2259 | 208 | 10.9 |
| 5-4 | 1.5 | 2.1 | 1.5 | 4616 | 1061 | 4.35 |
| 5-5 | | 2.8 | 2.0 | 4025 | 439 | 9.17 |
| 5-6 | | 3.5 | 2.5 | 3466 | 272 | 12.7 |

As can be seen from Table 5, when the concentration of cerium oxide increases from 1.0% to 1.5%, the rate of removing step-height increases by at least 1000 Å without significant change of the rate ratio. This means increased concentration of cerium oxide is advantageous in a process, which requires high rate of removing step-height.

### Example 6

In order to examine the effect of other additives, amino alcohol and/or ammonium hydroxide derivatives was (were) mixed with polyacrylic acid as listed in Table 6, and the pH was adjusted to 6.9 by the use of nitric acid. Every abrasive liquid was mixed to give 1% of cerium oxide and 1.5% of polyacrylic acid concentration to prepare a polishing composition, and polishing was carried out under the same condition as described in Example 1, to measure the rate of removing step-height and removal rate of plate.

TABLE 6

| | | | Rate of | Removal | |
|---|---|---|---|---|---|
| | | | removing | rate of | |
| Exp. | | | step-height | plate | Rate |
| No. | | Additive | (Å/min) | (Å/min) | ratio |
| 6-1 | L/S(3/7) | TEA | 3276 | 712 | 4.60 |
| 6-2 | L/S(1/1) | TEA | 3991 | 791 | 5.05 |
| 6-3 | L/S(1/1) | TEA/TMAH | 3844 | 803 | 4.79 |
| 6-4 | L/S(1/1) | DMAMP/TMAH | 4370 | 1050 | 4.16 |
| 6-5 | L/S(1/1) | AMP/TMAH | 4579 | 1422 | 3.22 |
| 6-6 | L/S(1/1) | TMAH | 2343 | 724 | 3.24 |
| Comp. | L/S(3/7) | KOH | 1351 | 712 | 1.90 |
| Ex. 6-1 | | | | | |
| Comp. | L/S(3/7) | NH₄OH | 2850 | 4025 | 0.71 |
| Ex. 6-2 | | | | | |

TEA: triethanol amine
DMAMP: 2-dimethylamino-2-methyl-1-propanol
TMAH: tetramethylammonium hydroxide
AMP: 2-amino-2-methyl-1-propanol

As can be seen from Table 6, the rate of removing step-height and auto-stopping function at the later stage of polishing are good when the composition contains aminoalcohol. In addition it is noticed that the rate of removing step-height and auto-stopping function at the later stage of polishing are good when tetramethyl ammonium hydroxide (TMAH) as a quaternary ammonium salt is contained alone or in addition to an aminoalcohol.

### Example 7

In order to examine the effect in a patterned wafer depending on pitch and pattern density [area of convex portion/(area of concave portion+area of convex portion), patterned wafers having various pitch and pattern density were evaluated. FIG. 2 illustrates change of mean thickness of concave portion and convex portion versus polishing time. The silica slurry was conventional slurry employed to polish silicon oxide layer in a process for manufacturing semiconductor having 11% of silica content. Slurry A is a polishing composition consisting of 1% of cerium oxide, 1.5% of polyacrylic acid (L/S=3/7) and 2.52% of triethanol amine, and Slurry B is a polishing composition consisting of 1.5% of cerium oxide, 1.7% of polyacrylic acid (L/S=3/7) and 2.38% of triethanol amine. The polishing condition of these slurries was the same as that of Example 1. It is found that in case of silica slurry, the thickness of insulating layer rapidly decreases even after removing step-height, but slurry A and B has much lowered rate of reducing the thickness of insulating layer after removing step-height (that is, after planarization).

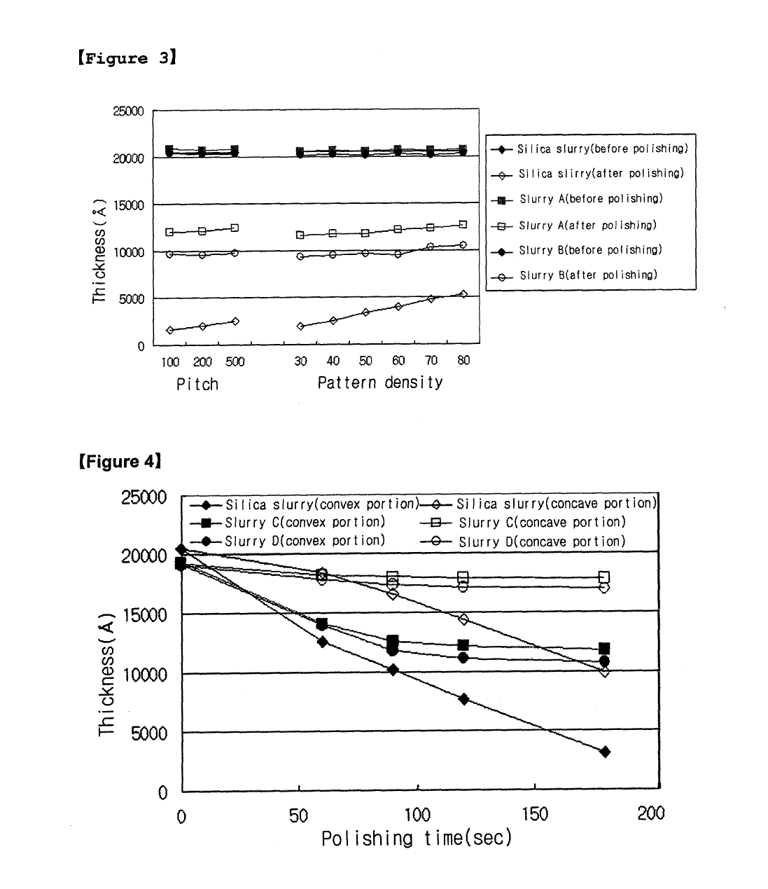

In addition, it was evaluated how the thickness of convex portion was affected by pitch and pattern density after polishing for 180 seconds. The results shown in FIG. 3 demonstrates that it has identical thickness before a polishing without any change depending on pitch or pattern density, while the silica slurry after polishing did not subjected to planarization because of large dependency on pitch or pattern density. On the other hand, in case of Slurry A and B composition, excellent planarization was achieved with only reducing about half of the thickness.

### Example 8

Cerium oxide dispersion was prepared as described in Example 1, hydroxycarboxylic acid listed in Table 7 was employed as an additive having auto-stopping function, and pH was adjusted to 6.9 by using KOH and nitric acid. Each abrasive liquid was prepared with the amount of hydroxycarboxylic acid shown in Table 7, while maintaining the concentration of cerium oxide as 1.5% constant. Substrate and polishing condition was the same as described in Example 1. Rate of removing step-height, removal rate of wafer plate and removal rate ratio (Rate of removing step-height/removal rate of plate) are shown in Table 7.

TABLE 7

| | | | Rate of | Removal | Rate of removing |
|---|---|---|---|---|---|
| | | | removing | rate of | step-height/ |
| Exp. | Additive and | | step-height | plate | Removal rate of |
| No. | content (%) | | (Å/min) | (Å/min) | plate |
| 7-1 | Malic acid | 1 | 2959 | 2376 | 1.3 |
| 7-2 | Malic acid | 2 | 2959 | 1666 | 1.8 |
| 7-3 | Tartaric | 1 | 4588 | 2273 | 2.0 |
| | acid | | | | |
| 7-4 | Tartaric | 2 | 4149 | 1127 | 3.7 |
| | acid | | | | |
| 7-5 | Citric | 0.5 | 5368 | 2305 | 2.3 |
| | acid | | | | |
| 7-6 | Citric | 1 | 3987 | 955 | 4.2 |
| | acid | | | | |
| 7-7 | Citric | 2 | 2367 | 352 | 6.7 |
| | acid | | | | |
| 7-8 | Gluconic | 0.5 | 5966 | 2145 | 2.8 |
| | acid | | | | |
| 7-9 | Gluconic | 1 | 5538 | 323 | 17.1 |
| | acid | | | | |
| Comp. | None | | 1999 | 4764 | 0.42 |
| 7-1 | | | | | |
| Comp. | Lactic | 1 | 2809 | 3738 | 0.75 |
| 7-2 | acid | | | | |
| Comp. | Lactic | 1.5 | 2271 | 3184 | 0.71 |
| 7-3 | acid | | | | |
| Comp. | Xylitol | 0.5 | | 3941 | |
| 7-4 | | | | | |
| Comp. | Xylitol | 2 | | 3129 | |
| 7-5 | | | | | |

As can be seen from Table 7, in case of Comp. Ex. 7-1 polished by abrasive particles of cerium oxide alone and Comp. Ex. 7-2 and Comp. Ex. 7-3 polished by a CMP slurry comprising lactic acid having one carboxylic group and one hydroxyl group, the rate of removing step-height was rather lower than the removal rate of wafer plate. In case of using polyhydric alcohols containing only hydroxyl group such as xylitol (Comp. Ex. 7-4 and Comp. Ex. 7-5), the removal rate of plate was high and did not exhibit auto-stopping function. It was confirmed that addition of a hydroxycarboxylic acid having at least 3 of total number of hydroxyl group and carboxylic group resulted in increase of rate of removing step-height, decrease of removal rate of plate, and thus raise of the rate ratio (rate of removing step-height/removal rate of plate) to achieve auto-stopping function. Among the hydroxycarboxylic acids listed in Table 7, the results from citric acid or gluconic acid (having at least 4 of total number of COOH and OH) were more excellent.

### Example 9

As was in Example 8, a cerium oxide dispersion having 1.5% of cerium oxide concentration was used, and polishing properties were evaluated in the same manner as in Example 8. The results are shown in Table 8.

An aminoalcohol was added to a hydroxycarboxylic acid or its salt, as an additive having auto-stopping function, and the pH was adjusted to 6.9 by using, if desired, nitric acid or TMAH or KOH. In case of adding a preservative, a lubricant or a surfactant, 2-methyl-3-isothiazolone was used as a preservative, glycerin or ethylene glycol as a lubricant, and Zonyl FSN (Dupont) as a surfactant.

In Table 8, TEA is triethanol amine, PAA is polyacrylic acid mixture (L/S=3/7, L: viscosity of aqueous 2.5% solution 1.67 cps, S: viscosity of aqueous 2.5% solution 1.21 cps).

TABLE 8

| | | | | | | | | Rate of |
|---|---|---|---|---|---|---|---|---|
| | | | | | Additional | Rate of | Removal | removing |
| | Carboxylic | | | | ingredient | removing | rate of | step-height/ |
| Exp. | acid & | | Amino alcohol | | and content | step-height | plate | Removal rate |
| No. | content(%) | | & content(%) | | (%) | (Å/min) | (Å/min) | of plate |
| Comp. | Acetic | 0.76 | TEA | 2 | | 4711 | 3210 | 1.5 |
| 8-1 | acid | | | | | | | |
| Comp. | Succinic | 0.54 | TEA | 1.5 | | 5767 | 4125 | 1.4 |
| 8-2 | acid | | | | | | | |
| Comp. | Succinic | 0.72 | TEA | 2 | | 1971 | 1768 | 1.1 |
| 8-3 | acid | | | | | | | |
| Comp. | Lactic | 1.00 | TEA | 0.68 | | 5259 | 2395 | 2.2 |
| 8-4 | acid | | | | | | | |
| Comp. | Lactic | 1.50 | TEA | 1.02 | | 3992 | 1418 | 2.8 |
| 8-5 | acid | | | | | | | |
| 8-1 | Malic | 0.65 | TEA | 1.5 | | 4340 | 383 | 11.3 |
| | acid | | | | | | | |
| 8-2 | Malic | 0.86 | TEA | 2 | | 3792 | 273 | 13.9 |
| | acid | | | | | | | |
| 8-3 | Tartaric | 0.74 | TEA | 1.5 | | 4086 | 224 | 18.2 |
| | acid | | | | | | | |
| 8-4 | Tartaric | 1.00 | TEA | 2 | | 3515 | 176 | 20.0 |
| | acid | | | | | | | |
| 8-5 | Citric | 0.61 | TEA | 1.5 | | 3935 | 337 | 11.7 |
| | acid | | | | | | | |
| 8-6 | Citric | 0.82 | TEA | 2 | | 3243 | 216 | 15.0 |
| | acid | | | | | | | |
| 8-7 | Gluconic | 0.10 | TEA | 0.83 | | 4837 | 371 | 13.0 |
| | acid | | | | | | | |
| 8-8 | Gluconic | 0.15 | TEA | 0.5 | | 5190 | 373 | 13.9 |
| | acid | | | | | | | |
| 8-9 | Gluconic | 0.44 | TEA | 1.5 | | 4343 | 167 | 26.0 |
| | acid | | | | | | | |
| 8-10 | Gluconic | 1.18 | TEA | 2 | | 1950 | 99 | 19.7 |
| | acid | | | | | | | |
| 8-11 | Tartaric | 0.52 | TEA | 2 | PAA | 4568 | 380 | 12.0 |
| | acid | | | | 0.52 | | | |
| 8-12 | Gluconic | 0.18 | TEA | 1.5 | PAA | 4892 | 268 | 18.3 |
| | acid | | | | 0.71% | | | |
| 8-13 | Gluconic | 0.71 | TEA | 1.5 | PAA | 3347 | 134 | 25.0 |
| | acid | | | | 0.18% | | | |
| 8-14 | Gluconic | 0.30 | TEA | 1 | Preservative | 4657 | 231 | 20.2 |
| | acid | | | | 0.05% | | | |
| 8-15 | Gluconic | 0.30 | TEA | 1 | EG | 4143 | 239 | 17.3 |
| | acid | | | | 0.6% | | | |
| 8-16 | Gluconic | 0.30 | TEA | 1 | Glycerin | 4223 | 237 | 17.8 |
| | acid | | | | 0.5% | | | |
| 8-17 | Gluconic | 0.30 | TEA | 1 | Zonyl FSN | 4752 | 230 | 20.7 |
| | acid | | | | 0.005% | | | |
| 8-18 | Potassium | 0.89 | TEA | 1.5 | | 2474 | 127 | 19.5 |
| | gluconate | | | | | | | |
| 8-19 | Potassium | 0.74 | TEA | 2.5 | PAA | 1990 | 145 | 13.7 |
| | gluconate | | | | 0.74% | | | |

Synergy of auto-stopping function due to addition of aminoalcohol was confirmed from large decrease of removal rate of plate and, as a result, increase of the ratio of rate of removing step-height/removal rate of plate, when TEA was added together with a hydroxyorganic acid. When a part of hydroxycarboxylic acid was substituted by PAA, the rate of removing step-height increased, while it was found that a surfactant, a water-soluble polymer, a lubricant and a preservative was additionally usable if desired, if not deteriorating the polishing function. In case of acetic acid, succinic acid and lactic acid, the ratio of rate of removing step-height/removal rate of plate was low, but from malic acid having at least 3 of total number of hydroxyl group and carboxylic group, the rate ratio abruptly increased to much enhance the auto-stopping function, showing excellent property of high rate of removing step-height.

### Example 10

Chemical mechanical polishing was carried out with changing the amount of citric acid and triethanol amine added, and evaluated. The abrasive liquid employed 1.5% by weight of cerium oxide, and the pH was adjusted to 6.9 by using nitric acid or KOH, if desired. The polishing composition was prepared according to the same procedure as Example 8.

Polishing was carried out under the same polishing condition as described in Example 1. Rate of removing step-height, removal rate of wafer plate and ratio of removal rate of pattern depending upon the amount of additives are shown in Table 3. The condition of surface of wafer plate was observed and evaluated as ∘: good, Δ: moderate, X: bad, according to the degree of occurrence of uneven stain.

TABLE 9

| | | | | | Rate of | |
|---|---|---|---|---|---|---|
| | | | | | removing | |
| | | | | Removal | step-height/ | |
| | Citric | | Rate of | rate of | Removal rate | Surface |
| Exp. | acid | TEA | removing | plate | of plate | of wafer |
| No. | % | % | step-height | (Å/min) | (Å/min) | plate |
| 9-1 | 0.16 | 1 | 4395 | 1166 | 3.8 | Δ |
| 9-2 | 0.28 | 1 | 4345 | 602 | 7.2 | Δ |
| 9-3 | 0.41 | 1 | 3970 | 703 | 5.6 | ∘ |
| 9-4 | 0.61 | 1.5 | 3935 | 337 | 11.7 | ∘ |
| 9-5 | 0.33 | 2 | 3606 | 301 | 12.0 | ∘ |
| 9-6 | 0.57 | 2 | 3273 | 264 | 12.4 | ∘ |
| 9-7 | 0.82 | 2 | 3243 | 216 | 15.0 | ∘ |

When citric acid having three carboxylic group and one hydroxyl group was used in combination with triethanol amine (as an aminoalcohol), the ratio of rate of removing step-height/removal rate of plate was 3.8 or higher and the auto-stopping function appeared. In particular, when the content of citric acid was 0.3% by weight or more, the ratio of rate of removing step-height/removal rate of plate was high, and the occurrence of stain on the surface of the wafer plate, as observed, decreased, being advantageous in that a uniform surface was obtainable.

In addition, when the amount of hydroxycarboxylic acid and aminoalcohol increases, the removal rate of plate decreases to enhance the auto-stopping function, and the degree of occurrence of stain on the surface is reduced to provide a uniform surface.

### Example 11

Polishing was carried out by changing the amount of the added gluconic acid and triethanol amine, and evaluated. The abrasive liquid employed 1.5% by weight of cerium oxide, and the pH was adjusted to 6.9. The polishing composition was prepared according to the same procedure described in Example 1.

Polishing was carried out under the same polishing condition as described in Example 8. Rate of removing step-height, removal rate of wafer plate and ratio of removal rate of pattern depending upon the amount of additives are shown in Table 10. The condition of surface of wafer plate was observed and evaluated as ∘: good, Δ: moderate, X: bad, according to the degree of occurrence of uneven stain.

TABLE 10

| | | | | | Rate of | |
|---|---|---|---|---|---|---|
| | | | | | removing | |
| | | | Rate of | Removal | step-height/ | |
| | Gluconic | | removing | rate of | Removal rate | Surface |
| Exp. | acid | TEA | step- | plate | of plate | of wafer |
| No. | % | % | height | (Å/min) | (Å/min) | plate |
| 10-1 | 0.47 | 0.4 | 4014 | 179 | 22.4 | ∘ |
| 10-2 | 0.47 | 0.8 | 4363 | 169 | 25.8 | ∘ |
| 10-3 | 0.3 | 1 | 4748 | 234 | 20.3 | ∘ |
| 10-4 | 0.18 | 1.5 | 4787 | 301 | 15.9 | Δ |
| 10-5 | 0.44 | 1.5 | 4184 | 155 | 27.0 | ∘ |
| 10-6 | 0.89 | 1.5 | 3124 | 125 | 25.0 | ∘ |
| 10-7 | 0.24 | 2 | 4680 | 228 | 20.5 | ∘ |
| 10-8 | 0.59 | 2 | 3032 | 135 | 22.5 | ∘ |
| 10-9 | 1.18 | 2 | 1950 | 99 | 19.7 | ∘ |

When gluconic acid, having one carboxylic group and five hydroxyl group, was used in combination with triethanol amine (as an aminoalcohol), the rate of removing step-height was high but the removal rate of plate was low, to provide excellent auto-stopping function. When the content of gluconic acid was 0.18% by weight, minute stain occurred on the surface of the wafer plate, so that it appeared that the content of gluconic acid of 0.3% by weight or more was more preferable.

From those results, it is found that, if the amount of hydroxycarboxylic acid and aminoalcohol increases, removal rate of plate decreases to strengthen the auto-stopping function, and the degree of occurrence of stain on the surface decreases to provide a uniform surface. However, if the concentration of gluconic acid is too high, it may be disadvantageous in that the rate of removing step-height tends to reduce, while if it is too low, it may be disadvantageous in that stain occurs on the surface of the wafer plate.

### Example 12

A polishing composition was prepared according to the same procedure as described in Example 8, but comprising 1.5% by weight of cerium oxide, 0.3% by weight of gluconic acid and 1% by weight of TEA. The pH was adjusted and modified by using nitric acid or KOH within the range described in Table 11:

TABLE 11

| | | | | Rate of removing |
|---|---|---|---|---|
| | | | Removal rate | step-height/Removal |
| | | Rate of removing | of plate | rate of |
| Exp. No. | pH | step-height | (Å/min) | plate(Å/min) |
| 11-1 | 5.5 | 2431 | 69 | 35.2 |
| 11-2 | 6.0 | 3632 | 129 | 28.2 |
| 11-3 | 6.4 | 4520 | 191 | 23.7 |
| 11-4 | 6.9 | 4748 | 238 | 19.9 |
| 11-5 | 7.3 | 4824 | 309 | 15.6 |
| 11-6 | 7.8 | 4930 | 485 | 10.2 |

From the results shown in Table 11, all the ratios of rate of removing step-height/removal rate of plate were maintained not less than 10 within the pH range designated. If the pH is low, it is found that the removal rate of plate decreases to strengthen the auto-stopping function but the rate of removing step-height also decreases. On the other hand, if the pH is high, it is found that the rate of removing step-height advantageously increases, but the removal rate of plate may also increase. Thus, it was confirmed that the pH range from 5 to 8 was more preferable.

### Example 13

Polishing properties were evaluated according to the same procedure as described in Example 8, as changing the content of cerium oxide as shown in Table 12. The polishing composition comprised 0.3% of gluconic acid, and 1% of TEA, and the pH was adjusted to 6.9.

TABLE 12

| | | Rate of | Removal rate | Rate of removing step- |
|---|---|---|---|---|
| Exp. | Cerium | removing | of | height/Removal rate of |
| No. | oxide % | step-height | plate(Å/min) | plate(Å/min) |
| 12-1 | 1.0 | 3261 | 160 | 20.4 |
| 12-2 | 1.5 | 4748 | 238 | 19.9 |
| 12-3 | 2.0 | 5315 | 318 | 16.7 |

From the results shown in Table 12, it is found that the rate of removing step-height and the removal rate of plate increase as the concentration of cerium oxide increases, and that the ratio of rate of removing step-height/removal rate of plate is also high, to well exhibit auto-stopping function.

### Example 14

In order to examine the effect in a patterned wafer depending on pitch and pattern density, patterned wafers were polished under the same condition as described in Example 7. FIG. 4 illustrates change of mean thickness of concave portion and convex portion versus polishing time. Slurry C is a polishing composition consisting of 1.5% of cerium oxide, 0.3% of gluconic acid and 1.0% of triethanol amine, and Slurry D is a polishing composition consisting of 1.5% of cerium oxide, 0.5% of tartaric acid and 1.0% of triethanol amine. It is found that in case of silica slurry, the thickness of insulating layer rapidly decreases even after removing step-height, but slurry C and D has very lowered rate of reducing the thickness of insulating layer after removing step-height (that is, after planarization).

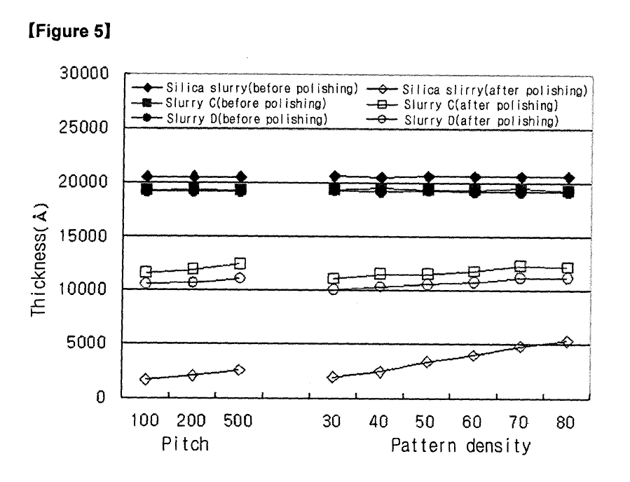

In addition, when examining the affect of pitch and pattern density versus the thickness of convex portion after polishing for 180 seconds (FIG. 5), it is demonstrated that, silica slurry has large dependency on pitch or pattern density, while Slurry C and D composition exhibit less dependency on pitch or pattern with less reduction in the thickness.

### INDUSTRIAL APPLICABILITY

The polishing composition according to the present invention removes step-height in polishing of a layer to be polished having high step-height, and has very low removal rate after removal of the step-height, thereby providing auto-stopping function. Thus, the present invention provides effects of shortening the vapor-deposition time of a layer to be polished, saving the raw material to be deposited, shortening the chemical-mechanical polishing time, saving the slurry employed and ensuring the process margin. The present invention advantageously provides saving of material cost and processing time to enhance the yield and productivity.

1. A chemical-mechanical polishing composition having auto-stopping function, which comprises
i) abrasive particles of metal oxide; and
ii) at least one compound(s) selected from the group consisting of an amino alcohol represented by Chemical Formula 1, a hydroxycarboxylic acid represented by Chemical Formula 2 or its salt, or a mixture thereof:
R₁—N(R₂)-A-OH [Chemical Formula 1]
(OH)ₙ—R—(COOH)ₘ [Chemical Formula 2]
wherein, A represents a linear or branched alkylene having from 2 to 5 carbon atoms, each group of R₁ and R₂ independently represent hydrogen or a linear or branched alkyl having from 1 to 5 carbon atom(s) with or without —OH substituent, R represents a linear or branched alkylene having from 1 to 6 carbon atom(s), a cycloalkylene having from 5 to 7 carbon atoms, a phenylene or an aralkylene group having from 7 to 9 carbon atoms, each of n and m represents an integer not less than 1, and n+m is not less than 3.

2. The chemical-mechanical polishing composition having auto-stopping function according to claim 1, which comprises from 0.1 to 20% by weight of abrasive particle of metal oxide and from 0.5 to 15% by weight of an aminoalcohol represented by Chemical Formula 1 or a mixture thereof on the basis of total weight of the polishing composition.

3. The chemical-mechanical polishing composition having auto-stopping function according to claim 1, which comprises from 0.1 to 20% by weight of abrasive particle of metal oxide and from 0.01 to 15% by weight of a hydroxycarboxylic acid represented by Chemical Formula 2 or its salt or a mixture thereof on the basis of total weight of the polishing composition.

4. The chemical-mechanical polishing composition having auto-stopping function according to claim 2, which comprises from 0.5 to 5% by weight of abrasive particle of metal oxide and from 1 to 10% by weight of an aminoalcohol represented by Chemical Formula 1 or a mixture thereof on the basis of total weight of the polishing composition, and has pH from 4 to 11.

5. The chemical-mechanical polishing composition having auto-stopping function according to claim 3, which comprises from 0.5 to 5% by weight of abrasive particle of metal oxide and from 0.05 to 10% by weight of a hydroxycarboxylic acid represented by Chemical Formula 2 or its salt or a mixture thereof on the basis of total weight of the polishing composition, and has pH from 4 to 11.

6. The chemical-mechanical polishing composition having auto-stopping function according to claim 1, which comprises from 0.5 to 5% by weight of abrasive particle of metal oxide, from 0.01 to 10% by weight of an aminoalcohol represented by Chemical Formula 1, and from 0.01 to 15% by weight of a hydroxycarboxylic acid represented by Chemical Formula 2 or its salt or a mixture thereof on the basis of total weight of the polishing composition, and has pH from 4 to 11.

7. The chemical-mechanical polishing composition having auto-stopping function according to claim 1, wherein the hydroxycarboxylic acid is selected from those compounds represented by Chemical Formula 2 and mixtures thereof:
(OH)ₙ—R—(COOH)ₘ [Chemical Formula 2]
wherein, R represents a linear or branched alkylene having from 1 to 6 carbon atom(s), a cycloalkylene having from 5 to 7 carbon atoms, a phenylene or an aralkylene group having from 7 to 9 carbon atoms, each of n and m represents an integer from 1 to 7, and n+m is not less than 4.

8. The chemical-mechanical polishing composition having auto-stopping function according to claim 1, wherein the hydroxycarboxylic acid is selected from the group consisting of gluconic acid, glucoheptonic acid, citric acid, tartaric acid, malic acid, citramalic acid, ketomalonic acid, dimethylolpropionic acid, diethylolpropionic acid, dimethylolbutyric acid, diethylolbutyric acid, glyceric acid, galactaric acid, saccharic acid, quinic acid, pentaric acid, 2,4-dihydroxybenzoic acid, gallic acid, and mixtures thereof.

9. The chemical-mechanical polishing composition having auto-stopping function according to claim 1, wherein the aminoalcohol is a compound selected from the group consisting of triethanol amine, 2-dimethylamino-2-methyl-1-propanol, 1-amino-2-propanol, 1-dimethylamino-2-propanol, 3-dimethylamino-1-propanol, 2-amino-1-propanol, 2-dimethylamino-1-propanol, 2-diethylamino-1-propanol, 2-diethylamino-1-ethanol, 2-ethylamino-1-ethanol, 1-(dimethylamino)-2-propanol, diethanolamine, N-methyldi ethanolamine, N-propyldiethanolamine, N-isopropyldiethanolamine, N-(2-methylpropyl)diethanolamine, N-n-butyldiethanolamine, N-t-butylethanolamine, N-cyclohexyldiethanolamine, N-dodecyldiethylamine, 2-(dimethylamino)ethanol, 2-diethylaminoethanol, 2-dipropylaminoethanol, 2-butylaminoethynol, 2-t-butylaminoethanol, 2-cycloaminoethanol, 2-amino-2-pentanol, 2-[bis(2-hydroxyethyl)amino]-2-methyl-1-propanol, 2-[bis(2-hydroxyethyl)amino]-2-propanol, N,N-bis(2-hydroxypropyl)ethanolamine, 2-amino-2-methyl-1-propanol, tris(hydroxymethyl)aminomethane and triisopropanolamine, or a mixture thereof.

10. The chemical-mechanical polishing composition having auto-stopping function according to claim 9, wherein the aminoalcohol is selected from the group consisting of triethanol amine, diethanolamine, monoethanolamine, 2-dimethylamino-2-methyl-1-propanol, tris(hydroxymethyl)aminomethane, triisopropanolamine, and mixtures thereof.

11. The chemical-mechanical polishing composition having auto-stopping function according to claim 1, wherein the abrasive particles of metal oxide is selected from the group consisting of silica, cerium oxide, zirconium oxide and aluminum oxide.

12. The chemical-mechanical polishing composition having auto-stopping function according to claim 11, wherein the abrasive particles of metal oxide is cerium oxide having from 50 to 500 nm of secondary particle diameter in the dispersion.

13. The chemical-mechanical polishing composition having auto-stopping function according to claim 11, which comprises from 0.5 to 5% by weight of cerium oxide, from 0.05 to 5% by weight of an aminoalcohol represented by Chemical Formula 1 or a mixture thereof and from 0.05 to 10% by weight of a hydroxycarboxylic acid represented by Chemical Formula 2 or a salt or a mixture thereof on the basis of total weight of the composition.

14. The chemical-mechanical polishing composition having auto-stopping function according to claim 13, which comprises from 1 to 3% by weight of cerium oxide, from 0.1 to 3% by weight of triethanol amine as an aminoalcohol and from 0.1 to 5% by weight of gluconic acid as a hydroxycarboxylic acid.

15. The chemical-mechanical polishing composition having auto-stopping function according to claim 1, which further comprises one or more component(s) selected from the group consisting of a pH modifier, a quarternary ammonium salt, a polymeric organic acid, a surfactant and a lubricant.

16. The chemical-mechanical polishing composition having an auto-stopping function according to claim 15, wherein the pH modifier is an inorganic acid, an organic acid, an inorganic base or an organic base.

17. The chemical-mechanical polishing composition having an auto-stopping function according to claim 15, which has a pH value from 5 to 8.

18. The chemical-mechanical polishing composition having auto-stopping function according to claim 15, wherein the quarternary ammonium salt is selected from the group consisting of ammonium hydroxide, tetramethylammonium hydroxide, tetraethylammonium hydroxide, tetrapropylammonium hydroxide and tetrabutylammoniumhydroxide.

19. The chemical-mechanical polishing composition having an auto-stopping function according to claim 15, wherein the polymeric organic acid is polyacrylic acid or a copolymer of polyacrylic acid.

20. The chemical-mechanical polishing composition having an auto-stopping function according to claim 15, which comprises an isothiazole compound as a preservative.

21. The chemical-mechanical polishing composition having an auto-stopping function according to claim 19, which comprises from 0.1 to 10% by weight of polyacrylic acid as a polymeric organic acid.

22. A process for polishing a substrate by using a chemical-mechanical polishing composition having an auto-stopping function according to claim 1.
